(19) United States
(12) Patent Application Publication
(10) Pub. No.: US 2002/0007378 A1
(43) Pub. Date: Jan. 17, 2002

(54) Page display method for selecting and displaying page depending on customer level of user

(75) Inventors: Hisashi Tanaka, Tokyo (JP); Katsumi Sasaki, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/903,895

(22) Filed: Jul. 12, 2001

(30) Foreign Application Priority Data
Jul. 14, 2000 (JP) 2000-214775

(51) Int. Cl. G06F 17/21

(52) U.S. Cl. 707/513

(57) ABSTRACT

A page display method for selecting and displaying a page corresponding to the customer level of a user is disclosed. As a user accesses a home page of a seller, makes user registration, and purchases a commodity through online shopping, the customer level of the user is raised from “visitor,” “registrant,” “normal customer,” and finally “preferred customer.” The customer level is stored as customer information in a customer information database. When a user makes access to a seller server, the seller server selects a page depending on the customer level of the user from a plurality of pages stored in a display information database and displays the selected page on a user terminal.

### BACKGROUND OF THE INVENTION

1. Field of the Invention

The present invention relates to a page display method and system for displaying a page on a user terminal by a server operated by a seller, company or the like when the user terminal establishes connection to the server through the Internet.

2. Description of the Related Art

In recent years, online shopping for selling and purchasing commodities through the Internet is being put to use. In addition, various companies generally provide information on them, information on products sold by them or the like through the Internet.

A user who attempts to obtain such information or to utilize online shopping operates a user terminal to establish a connection through the Internet to a server operated by a seller or company. When engaging in online shopping, the user views a home page of the seller, selects a commodity which the user wishes to purchase from commodities sold on the home page, and orders the commodity, thereby making it possible to purchase the commodity. On the other hand, a user who attempts to obtain information on a company or the like can obtain desired information by viewing a home page of the company.

A seller or company running such a home page configures a displayed page of the home page to allow a user who has made access thereto to obtain as much useful information as possible. A home page, however, has limited space, and thus there is a limitation on the amount of information which can be directly displayed on the home page. For this reason, a mark for link to another web page is provided on a home page, and a user can search various web pages by selecting the mark to obtain desired information.

Users who have made access to such a home page of a seller or company may vary in desired information, objects of the access or the like. For example, users who have made access to a home page of a seller running online shopping include users at various levels such as those who attempt to shop online for the first time, or those who have shopped online many times and are familiar with its mechanism.

In a conventional page display method, however, only one home page is provided for users who have made access thereto, and thus only uniform information can be transmitted to the users who have made access. As a result, some users may experience the inconvenience of having to view unnecessary information each time they access a home page of a seller, or the inconvenience of having to perform complicated operations each time for reaching a web page to obtain necessary information.

### SUMMARY OF THE INVENTION

It is an object of the present invention to provide a page display method capable of appropriately providing a user with information which satisfies the demands of the user.

To achieve the aforementioned object, according to the page display method of the present invention, a plurality of pages are previously prepared corresponding to customer levels, and when a user terminal accesses a server, a page to be displayed is selected from the previously prepared pages depending on the current customer level of the user and the selected page is displayed, thereby allows appropriate provision of information which satisfies the demands of the user who has made access to the server.

The displayed page may be a page initially displayed when the user terminal makes access. In addition, the layout of a page to be displayed may be changeable by operations through the user terminal.

This arrangement allows a page including information desired by a user and information appealing to the user to be displayed on the user terminal.

According to another aspect of the present invention, the page is of a hierarchical structure in which the page is divided into a plurality of areas each divided into one or more smaller areas. In this case, the position, contents, and size are changeable for each area, and the number of smaller areas formed in an area is changeable.

The areas in the respective levels of the hierarchy may be associated with one another. Ranges of positions, contents, and sizes of each area, and the numbers of smaller areas formed in an area may be previously determined by a lower level of the hierarchy such that changes are possible within the ranges.

In addition, some of the plurality of areas may be formed to allow no change by operations through the user terminal.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram showing a configuration of a page display system for a page display method according to a first embodiment of the present invention;

FIG. 2 shows an example of customer information stored in customer information database 40;

FIG. 3a shows an example of a displayed page selected by seller server 10 when a customer level is “visitor”;

FIG. 3b shows an example of a displayed page selected by seller server 10 when a customer level is “registrant”;

FIG. 4a shows an example of a displayed page selected by seller server 10 when a customer level is “normal customer”;

FIG. 4b shows an example of a displayed page selected by seller server 10 when a customer level is “preferred customer”;

FIG. 5 is a schematic diagram for explaining a relationship among zones, containers, and items;

FIG. 6 shows an example of a page before customization according to a page display method according to a second embodiment of the present invention; and

FIG. 7 shows an example of the page after customization according to the page display method of the second embodiment of the present invention.

### DETAILED DESCRIPTION OF THE PREFERRED EMBODIMENTS

First Embodiment

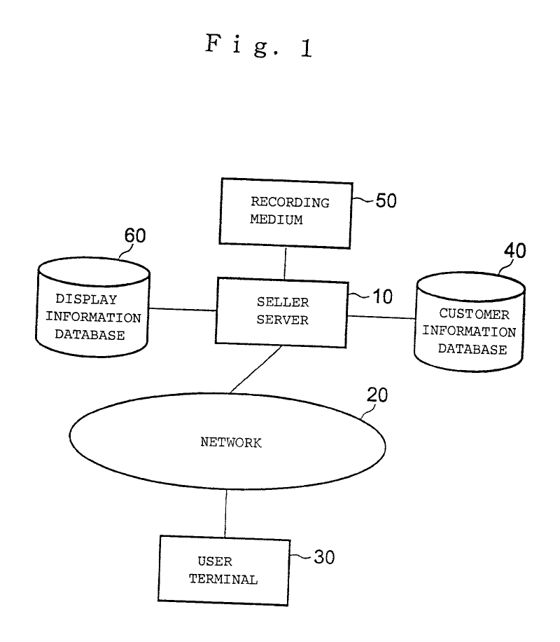

Referring now to FIG. 1, there is shown a page display system for performing a page display method according to a first embodiment of the present invention, comprising seller server 10, network 20 such as the Internet, user terminal 30, customer information database 40, recording medium 50, and display information database 60. For simplicity, only one user terminal is shown in the embodiment. In an actual page display system, however, a plurality of user terminals may be connected to seller server 10 through network 20.

In addition, the embodiment is illustrated in a case where a seller running online shopping displays pages on a home page for selling commodities through the network.

Recording medium 50 has a program stored thereon for performing the page display method of the embodiment. The program is read from recording medium 50 by seller server 10 for controlling the operation of seller server 10. Seller server 10 executes the following procedures under the control of the program. Recording medium 50 may be in the forms of a magnetic disc, a semiconductor memory, and so on.

User terminal 30 is operated by a user who desire to purchase a commodity, and has the function of establishing a connection to network 20. Seller server 10 is a server for providing online shopping. User terminal 30 can establish a connection to seller server 10 through network 20 to acquire information on a commodity, examine it, and order the commodity on a home page of seller server 10.

When a user accesses seller server 10, seller server 10 reads a customer level currently stored for the user from customer information database 40, selects display information depending on the customer level of the user from display information stored in display information database 60, and displays the information on user terminal 30.

Seller server 10 stores, in customer information database 40, “visitor” as the customer level of a user who has not made user registration, “registrant” as the customer level of a user who has made user registration but has not yet purchased a commodity, “normal customer” as the customer level of a user who has made user registration and has already purchased a commodity through online shopping, and “preferred customer” as the customer level of a user who has made user registration and has purchase experience through online shopping which satisfies a certain condition.

That is, as a user accesses the home page of the seller, makes user registration, and purchases a commodity through online shopping, the customer level of the user is raised in the order of “visitor,” “registrant,” “normal customer,” and finally “preferred customer.”

An example of a condition in purchase experience for raising the customer level from “normal customer” to “preferred customer” is that a user has purchased commodities through online shopping whose total price reaches a certain amount or more, or a user has utilized online shopping a certain number of times or more.

Customer information database 40 is connected to seller server 10 and has customer information stored therein such as the customer level, name, address, purchased commodity histories, and ID number for each user.

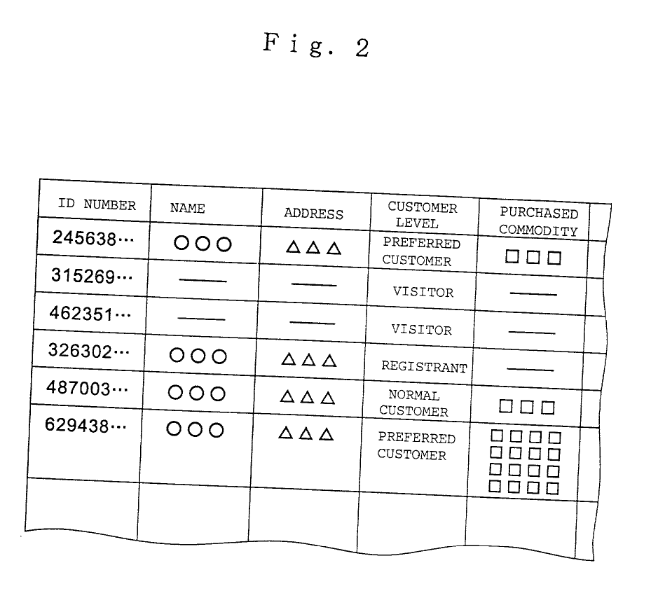

FIG. 2 shows an example of the customer information stored in customer information database 40. In FIG. 2, for users at the customer level of “visitor,” only their ID numbers are stored since they have not made user registration yet. For a user at the customer level of “registrant,” his or her name and address are stored in addition to his or her ID number since he or she has already made user registration. For users at the customer levels of “normal customer” and “preferred customer,” information on the previously purchased commodities is stored in addition to the aforementioned information.

The ID number refers to a number for identifying a user who has made access to the home page. Seller server 10 can identify a user who has made access by using data called a cookie file or the like. That is, the ID number refers to a number produced on the basis of the cookie file.

In general, the cookie file is data which allows a user to be identified and is stored on a hard disk or the like on a user terminal when a user accesses a home page or the like in a site. When the user accesses the home page in the site the next time, the site can identify the user who has made access using the cookie file.

Display information database 60 is connected to seller server 60 and has a plurality of pieces of display information previously stored therein corresponding to customer levels.

Although not shown, backup means may be provided for holding the functions of seller server 10 and the information accumulated in seller server 10, and the information stored in customer information database 40, display information database 60, and recording medium 50.

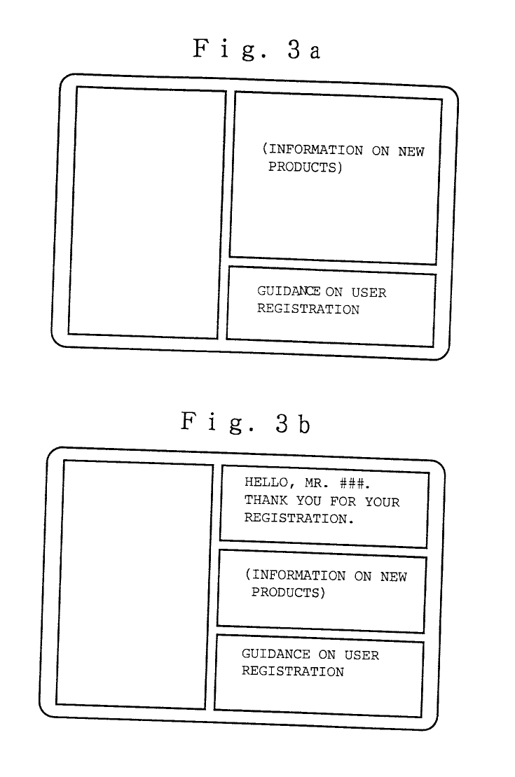

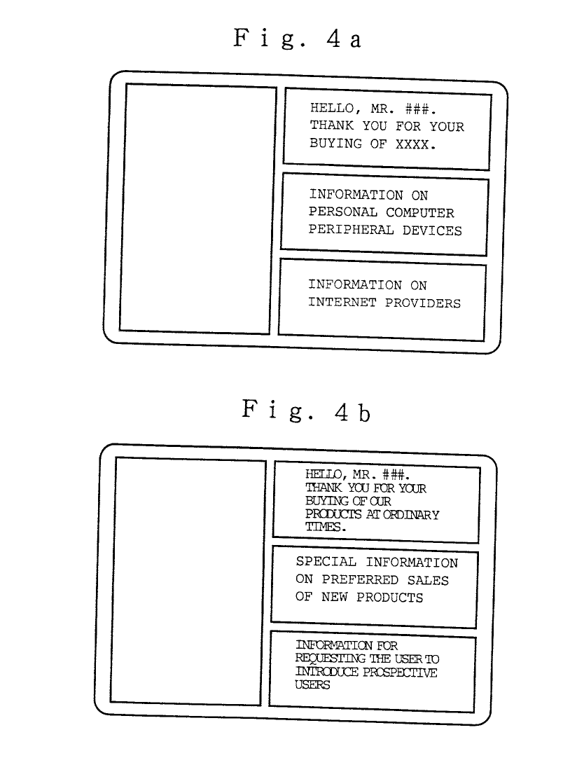

Next, the page display method of the embodiment will be described with reference to FIGS. 3 and 4.

FIG. 3a shows a page selected and displayed by seller server 10 when the customer level is “visitor.” FIG. 3b shows a page selected and displayed by seller server 10 when the customer level is “registrant.” FIG. 4a shows a page selected and displayed by seller server 10 when the customer level is “normal customer.” FIG. 4b shows a page selected and displayed by seller server 10 when the customer level is “preferred customer.”

When a user at the customer level of “visitor” makes access, seller server 10 selects and displays a page as shown in FIG. 3a from the pages stored in display information database 60. Since the user for whom the page is displayed has not made user registration yet, the page has information for guidance on user registration in addition to information on new products. Seller server 10 performs similar page display when a user with no information in customer information database 40 makes access, and newly registers the user as a user at the customer level of “visitor” in customer information database 40.

When a user at the level of “registrant” makes access, seller server 10 selects and displays a page as shown in FIG. 3b from the pages stored in display information database 60. Since the user for whom the page is displayed has already made user registration, the user is provided with not only normal information such as on new products but also information targeted at that user and information on online shopping.

When a user at the customer level of “normal customer” makes access, seller server 10 selects and displays a page as shown in FIG. 4a from the pages stored in display information database 60. Since the user for whom the page is displayed has already made user registration and has purchased a commodity through online shopping, the user is provided with not only information targeted at that user but also information according to the past purchase histories.

The provision of the information according to the past purchase histories refers to, for example, the provision of information on personal computer peripheral devices such as printers, or information on Internet providers to a user who has purchased a personal computer.

When a user at the customer level of “preferred customer” makes access, seller server 10 selects and displays a page as shown in FIG. 4b from the pages stored in display information database 60. Since the user for whom the page is displayed has already made user registration and has purchase experience of commodities through online shopping which satisfies a certain condition, the user is provided with not only information targeted at that user and information according to the past purchase histories but also special information on preferred sales of new products, information for requesting the user to introduce prospective users.

With the page display method of the embodiment, the pages to be displayed are previously prepared for the respective customer levels in display information database 60 and seller server 10 selects and displays one of the pages on the user terminal according to the customer level of a user who has made access to seller server 10, thereby making it possible to appropriately provide information which satisfies the demands of the user who has made access to seller server 10.

While the embodiment has been described in a case where pages are displayed on the home page for selling commodities by the seller through the network, the present invention is not limited thereto. The present invention is also applicable to a case where a company displays pages on user terminal 30 through a network to display pages on a home page for providing information on the company, for example.

While the embodiment has been described by using the four customer levels of “visitor,” “registrant,” “normal customer,” and “preferred customer,” the number of the customer levels, the condition for determining the customer level of a user and the like may be set in any way. For example, a customer level may be changed according to the number of accesses to a server, or a customer level may be changed according to the frequency of accesses (the number of accesses in a certain time period).

In addition, while the embodiment has been described for the pages displayed first on user terminal 30 when a user accesses seller server 10, the present invention is not limited thereto and is also applicable to a system for displaying a page on user terminal 30 at all points in time. For example, it is possible to display the same page first on user terminal 10 when any user accesses seller server 10 and to display next a page depending on the customer level of the user.

Second Embodiment

Next, a page display method of a second embodiment of the present invention will be described. The aforementioned first embodiment is the method for selecting and displaying a page depending on the customer level of a user, and when the method according to the first embodiment is used, pages displayed on user terminal 30 are formed by a manufacturer or the like. However, it is a user that knows most accurately which information is desired by or appealing to the user, and the contents of a home page provided by a manufacturer does not necessarily match the information desired by a user.

The second embodiment improves such a problem and allows a user to change a page configuration such that a home page provides information most suitable for the user.

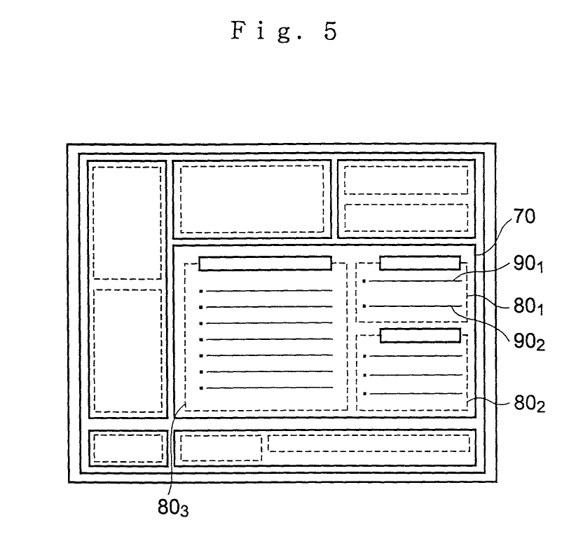

Prior to description of the page display method of the embodiment, the configuration of a home page is first described. The home page generally comprises three elements of zones, containers, and items as shown in FIG. 5.

A zone has a large area and refers to one of a plurality of areas into which the home page is divided. A container has a smaller area and refers to one of a plurality of smaller areas into which a zone is divided. Items are articles constituting contents of each container and comprise a specific heading, index information, link, text and the like.

For example, in FIG. 5, zone 70 comprises three containers 80₁ to 80₃, and container 80₁ comprises two items 90₁, 90₂.

A system for performing the page display method of the present embodiment is similar in configuration to that shown in FIG. 1. In the present embodiment, however, display information database 60 has a page to be displayed stored therein for each user, and when a user makes access to seller server 10, seller server 10 reads a page corresponding to the user from display information database 60 and displays it on user terminal 30. The configurations of pages stored in display information database 60 are changeable by operations from the user terminal.

According to the embodiment, when a user who has made access has not been registered yet in customer information database 40, seller server 10 displays a previously prepared initial page on user terminal 30.

A user can change the position, size, contents or the like of each zone, container, item or the like on a home page displayed in response to access to seller server 10 by operating user terminal 30. The changed display information is stored in display information database 60 in correspondence with the user.

When the user makes access again, seller server 10 reads the page corresponding to the user from display information database 60 and displays it on user terminal 30.

Thus, when the user who once changed the configuration of the displayed page accesses seller server 10, the page changed by himself is displayed, and he can shop online or obtain various information by using the homepage which provides information he or she desires or information appealing to him or her.

In this manner, in the page display method of the embodiment, a page is of a hierarchical structure in which the page is divided into a plurality of areas of zones, and a zone is divided into a plurality of smaller areas of containers or items. It is possible to change the position, contents, and size for each zone, container and item, the number of containers formed in the area of a zone, and the number of items formed in the area of a container.

In addition, in the page display method of the embodiment, a container belonging to a zone is associated with the zone, and an item belonging to a container is associated with the container. Ranges of positions, contents, and sizes of each area, and the numbers of smaller areas formed in an area are previously determined by a lower level of the hierarchy, and settings are made to allow changes within the ranges. Specifically, ranges of positions, contents, and sizes of a zone, and the numbers of containers formed in the zone are previously determined by the container which corresponds to a lower level of the hierarchy, and settings are made to allow changes within the ranges. In addition, ranges of positions, contents, and sizes of a container, and the numbers of items formed in the container are previously determined by the item which corresponds to a lower level of the hierarchy, and settings are made to allow changes within the ranges.

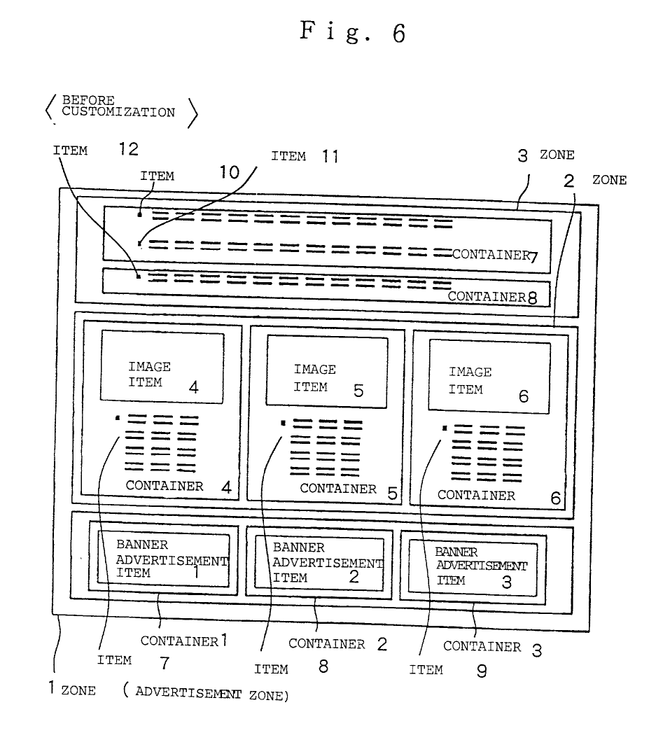

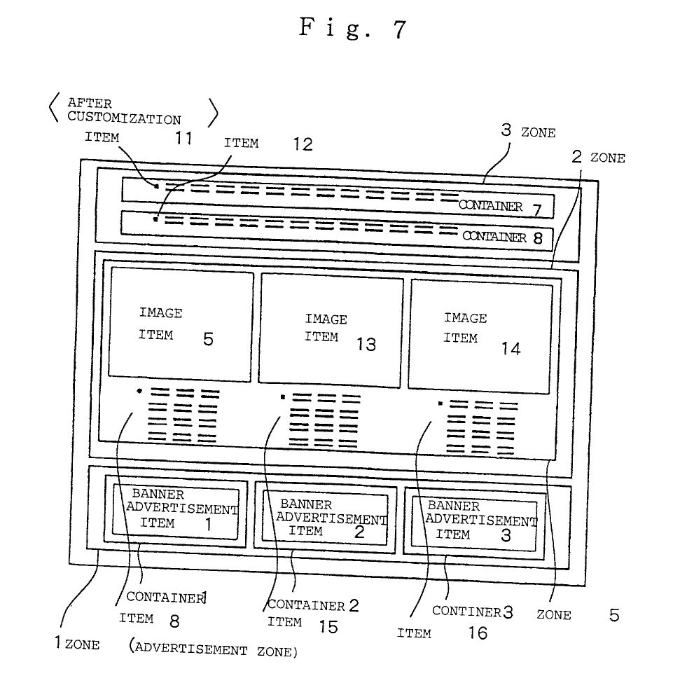

An example of a page on which a user has changed (customized) its configuration according to the page display method of the embodiment is described with reference to FIGS. 6 and 7. FIG. 6 shows an example of a page before customization according to the page display method of the embodiment, while FIG. 7 shows an example of the page after customization according to the page display method of the embodiment.

The following description is made in a case where the respective areas are arranged in a three-level hierarchy, and for the three levels, zones 1 to 3, containers 1 to 8, and items 1 to 16 can be set.

In FIG. 6 showing a page before customization, the page is divided into three areas of zones 1 to 3. For example, zone 1 has the meaning of an advertisement zone and is defined to have three containers placed therein. Zone 2 has the meaning of a commodity presentation zone and is defined to have containers of the number in a range of 1 to 3. Zone 3 has the meaning of a contact zone from a site and is defined to include two or more containers.

Containers 1 to 3 have the meaning of a banner advertisement and are set to allow no change in positions or size. Containers 1 to 3 are defined such that only one item can be provided in one container.

Containers 4 to 6 have the meanings for recommended notebook personal computers, desktop personal computers, and peripheral devices, and are set such that each of them must display one or more items. Containers 4 to 6 are defined to allow display of a plurality of image items and text items.

Containers 7, 8 have the meanings for information and for use conditions. The container for use conditions is set to allow no change in size or erasure, and is defined to allow display of a plurality of text items.

Items 1 to 3 have the meaning of a banner advertisement. Item 4 has the meaning of a photograph of a notebook personal computer, item 5 has the meaning of a photograph of desktop personal computer 1, item 6 has the meaning of a photograph of a TA (Terminal Adapter), item 7 has the meaning of basic information of the notebook personal computer, item 8 has the meaning of basic information of desktop personal computer 1, and item 9 has the meaning of basic information of the TA.

Item 10 includes an ID registration request document. Item 11 includes an announcement of new products. Item 12 has the meaning of use regulations.

FIG. 7 shows the displayed page to which a user has made changes (customization).

In FIG. 7, item 13 has the meaning of a photograph of desktop personal computer 2, item 14 has the meaning of a photograph of desktop personal computer 3, item 15 has the meaning of basic information of desktop personal computer 2, and item 16 has the meaning of basic information of desktop personal computer 3.

In this manner, a user makes changes to the page shown in FIG. 6 such that information desired by the user and information appealing to the user are displayed, thereby obtaining the page shown in FIG. 7. When the user accesses seller server 10, the page shown in FIG. 7 is displayed on user terminal 30.

While the embodiment has been described in a case where each zone, container, item and the like can be changed in position, size, contents or the like, some of them may be formed to allow no change by a user. For example, disadvantages arise when a user can delete an advertisement zone for which advertisement rates are collected or a zone for a display which is made obligatory by law. It is thus preferable not to allow changes by a user in such a zone. For the same reason, some of the containers and items may be set not to allow a user to change them.

The zones may be formed to allow no change by a user, and the containers and items in the zones may be formed to allow changes by a user.

In addition, while the page display method of the embodiment has been described in a case where the page configuration is arranged in the three-level hierarchy including the zones, containers, and items, the number of levels in the hierarchy of the layered page configuration is not limited to three in the present invention. The present invention is applicable similarly to any case where the configuration of a page is of a hierarchical structure of a plurality of levels such as two, four, five or the like.

While the page display method of the embodiment has been described in a case where the present invention is applied to page display on a public home page on the Internet, the present invention is not limited to such a case and is applicable similarly to a page displayed on an OS (Operating System) or a page displayed when application software is started.

While preferred embodiments of the present invention have been described using specific terms, such description is for illustrative purposes only, and it is to be understood that changes and variations may be made without departing from the spirit or scope of the following claims.

What is claimed is:

1. A method of displaying a page on a user terminal by a server when said user terminal establishes a connection to said server through a network, said method comprising the steps of:
previously preparing a plurality of pages each corresponding to a customer level; and
when said user terminal accesses said server, selecting and displaying one of said previously prepared pages corresponding to a current customer level of a user of said user terminal.

2. The method according to claim 1, wherein said page is a page initially displayed when said user terminal makes access to said server.

3. The method according to claim 1, wherein the layout of said page is changeable by operations through said user terminal.

4. A method of displaying a page on a user terminal by a server when said user terminal establishes a connection to said server through a network, wherein said page is of a hierarchical structure in which said page is divided into a plurality of areas each divided into one or more smaller areas, and a position, contents, and a size are changeable for said each area and the number of smaller areas formed in each area is changeable.

5. The method according to claim 4, wherein said areas in respective levels of the hierarchy are associated with one another, and ranges of positions, contents, and sizes of said each area, and the numbers of said smaller areas formed in each area are previously determined by a lower level of the hierarchy, and changes can be made within said ranges.

6. The method according to claim 4, wherein some of said plurality of areas are set not to allow changes by operations through said user terminal.

7. A page display system comprising:
a user terminal connected to a network;
a customer information database storing customer information including a customer level for each user;
a display information database previously storing a plurality of pieces of display information corresponding to said customer levels; and
a server for reading, when a user makes access thereto, a customer level currently stored for said user from said customer information database, selecting display information corresponding to said customer level of said user from said plurality of pieces of display information stored in said display information database, and displaying said selected information on said user terminal.

8. The system according to claim 7, wherein said page is a page initially displayed when said user terminal makes access to said server.

9. The system according to claim 7, wherein the layout of said page is changeable by operations through said user terminal.

10. A page display system for displaying a page on a user terminal by a server when said user terminal establishes connection to said server through a network, wherein said page has a hierarchical structure in which said page is divided into a plurality of areas each divided into one or more smaller areas, and a position, contents, and a size are changeable for said each area and the number of smaller areas formed in each area is changeable.

11. The system according to claim 10, wherein said areas in respective levels of the hierarchy are associated with one another, and ranges of positions, contents, and sizes of said each area, and the numbers of said smaller areas formed in each area are previously determined by a lower level of the hierarchy, and changes can be made within said ranges.

12. The system according to claim 10, wherein some of said plurality of areas are set not to allow changes by operations through said user terminal.

13. A server for displaying a page on a user terminal when said user terminal establishes connection to said server through a network, wherein said server reads, when a user makes access thereto, a customer level currently stored for said user from a customer information database, selects display information corresponding to said customer level of said user from display information stored in said display information database, and displays said selected information on said user terminal.

14. The server according to claim 13, wherein said page is a page initially displayed when said user terminal makes access to said server.

15. The server according to claim 14, wherein the layout of said page is changeable by operations through said user terminal.

16. A server for displaying a page on a user terminal when said user terminal establishes a connection to said server through a network, wherein said page is of a hierarchical structure in which said page is divided into a plurality of areas each divided into one or more smaller areas, and a position, contents, and a size are changeable for said each area and the number of smaller areas formed in each area is changeable.

17. The server according to claim 16, wherein said areas in respective levels of the hierarchy are associated with one another, and ranges of positions, contents, and sizes of said each area, and the numbers of said smaller areas formed in each area are previously determined by a lower level of the hierarchy, and changes can be made within said ranges.

18. The server according to claim 16, wherein some of said plurality of areas are set not to allow changes by operations through said user terminal.

19. A computer program for causing a computer to perform a method of displaying a page on a user terminal by a server when said user terminal establishes connection to said server through a network, said program comprising:
previously preparing a plurality of pages corresponding to customer levels, and when said user accesses said server, reading a customer level currently stored for said user; and
selecting and displaying one of said previously prepared pages corresponding to said read customer level.

20. The program according to claim 19, wherein said page is a page initially displayed when said user terminal makes access to said server.

21. The program according to claim 19, wherein the layout of said page is changeable by operations through said user terminal.

22. A program for causing a computer to perform a method of displaying a page on a user terminal by a server when said user terminal establishes connection to said server through a network, wherein said page is of a hierarchical structure in which said page is divided into a plurality of areas each divided into one or more smaller areas, and a position, contents, and a size are changeable for said each area and the number of smaller areas formed in each area is changeable.

23. The program according to claim 22, wherein said areas in respective levels of the hierarchy are associated with one another, and ranges of positions, contents, and sizes of said each area, and the numbers of said smaller areas formed in each area are previously determined by a lower level of the hierarchy, and changes can be made within said ranges.

24. The program according to claim 22, wherein some of said plurality of areas are set not to allow changes by operations through said user terminal.
